(19) United States
(12) Patent Application Publication
(10) Pub. No.: US 2017/0193005 A1
(43) Pub. Date: Jul. 6, 2017

(54) PROTECTION METHOD AND DEVICE FOR METADATA OF FILE

(71) Applicants: INDUSTRY-UNIVERSITY COOPERATION FOUNDATION HANYANG UNIVERSITY, Seoul (KR); UNIST (ULSAN NATIONAL INSTITUTE OF SCIENCE AND TECHNOLOGY), Ulsan (KR)

(72) Inventors: You Jip WON, Seongnam (KR); Beom Seok NAM, Ulsan (KR)

(21) Appl. No.: 15/376,553

(22) Filed: Dec. 12, 2016

(30) Foreign Application Priority Data
Dec. 31, 2015 (KR) 10-2015-0191670

(51) Int. Cl. G06F 17/30

(52) U.S. Cl. CPC G06F 17/30191; G06F 17/30575; G06F 17/30176

(57) ABSTRACT

Disclosed is a protection method and device for metadata of a file. The protection method may include pre-allocating, to a storage device, a preset quantity of initialized blocks for a journal file and journaling, in the storage device, updated metadata of the journal file by calling a data synchronization function.

### CROSS-REFERENCE TO RELATED APPLICATION(S)

This application claims the priority benefit of Korean Patent Application No. 10-2015-0191670 filed on Dec. 31, 2015, in the Korean Intellectual Property Office, the disclosure of which is incorporated herein by reference for all purposes.

### BACKGROUND

1. Field

One or more example embodiments may be used in a field of storing a great quantity of data, and be more effectively used in a field of using a method of writing database restoration information with a buffer-based input and output, a direct input and output (DIO), or an input and output using a buffer.

2. Description of Related Art

In related arts, data stored in a user buffer may be temporarily stored in a page cache, and the data stored in the page cache may be written in a storage device through a function such as, for example, fsync( ) and fdatasync( ). In addition, the data may be immediately written in the storage device through a direct input and output (DIO) without being stored in the page cache.

Through the function fsync( ), a file system may journal updated metadata of each file. Through the function fdatasync( ), when file blocks are allocated or not allocated, the file system may journal the updated metadata. A DIO write operation may not involve any file system journaling.

A write operation may be classified into two types of a process, for example, a process of allocating a write operation and a process of not allocating a write operation. The process of allocating a write operation may include updating various pieces of metadata, for example, a block bitmap, an inode table, and an intermediate node block. The process of not allocating a write operation may not involve allocation of file blocks, but may include updating a field-related access time and an initialized flag in metadata.

In both the processes of allocating a write operation and not allocating a write operation, the function fsync( ) may journal updated metadata. In the process of allocating a write operation, the function fdatasync( ) may perform the same operation as the function fsync( ). In the process of not allocating a write operation, the function fdatasync( ) may not journal any metadata. In both the processes of allocating a write operation and not allocating a write operation, the DIO may not involve file system journaling. Through the DIO, updated metadata may be prone to be lost.

In related arts, when the DIO is not used, the file system journaling through which metadata is stored in the page cache and the metadata is synchronized to the storage device through the function fsync( ) or the function fdatasync( ) may occur. However, due to such an unnecessary file system journaling, an amount of an input and output of a database may increase and a life of the storage device may be reduced.

### SUMMARY

An aspect provides a protection method and device that may improve a performance of a storage device and extend a life of the storage device by significantly reducing an amount of an input and output that is actually generated when synchronizing contents written in a file to the storage device.

According to an aspect, there is provided a protection method including pre-allocating, to a storage device, a preset quantity of initialized blocks for a journal file and journaling, in the storage device, updated metadata of the journal file by calling a data synchronization function.

The protection method may further include committing a log, which is database restoration information, to the blocks after the journaling.

The committing may include writing the log in the blocks pre-allocated to the storage device from a database, through a direct input and output (DIO) method or a buffered input and output (IO) method.

The journaling may include storing, in the storage device, the metadata of the journal file by synchronizing the metadata through the data synchronization function.

The blocks allocated to the storage device may be initialized by filling the blocks with zero, or applying a discard command to the storage device.

The protection method may further include re-allocating a preset quantity of blocks when all the allocated blocks are full through the committing of the log.

When a size of the journal file changes in response to the re-allocation of the blocks, the protection method may further include journaling the metadata of the journal file by synchronizing the metadata.

According to an aspect, there is provided a protection device including a processor. The processor may pre-allocate, to a storage device, a preset quantity of initialized blocks for a journal file and journal, in the storage device, updated metadata of the journal file by calling a data synchronization function.

The processor may commit a log, which is database restoration information, to the blocks after journaling the metadata.

The processor may write the log in the blocks pre-allocated to the storage device from a database through a DIO method or a buffered IO method.

The processor may perform the journaling by storing, in the storage device, the metadata of the journal file by synchronizing the metadata through the data synchronization function.

The blocks allocated to the storage device may be initialized by filling the blocks with zero, or applying a discard command to the storage device.

When all the allocated blocks are full through the committing of the log, the processor may re-allocate a preset quantity of blocks.

When a size of the journal file changes in response to the re-allocation of the blocks, the processor may journal the metadata of the journal file by synchronizing the metadata.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an overall configuration according to an example embodiment;

FIG. 2 is a flowchart illustrating a protection method for metadata of a file according to an example embodiment; and

FIG. 3 is a diagram illustrating an example of a protection method for metadata of a file according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

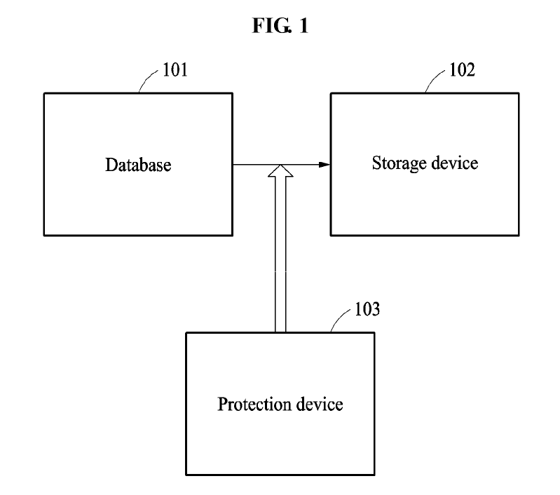

FIG. 1 is a diagram illustrating an overall configuration according to an example embodiment.

Referring to FIG. 1, a database 101, a storage device 102, and a protection device 103 are included. The protection device 103 may perform a protection method for metadata of a file, and may be a processor supporting a file system included in a terminal.

The protection device 103 may pre-allocate a preset quantity of initialized blocks for a file. The protection device 103 may journal metadata of a generated file by calling fdatasync( ).

In detail, the protection device 103 may pre-allocate, to the storage device 102, initialized blocks for a journal file. The protection device 103 may journal metadata of the journal file by synchronizing the metadata to the storage device 102 through fdatasync( ). Subsequently, logs may be committed to the blocks pre-allocated to the journal file through a direct input and output (DIO) or a buffered input and output (IO). The metadata of the journal file may refer to an attribute such as, for example, a size of the journal file.

The buffered IO may refer to a method of temporarily writing the logs in a page cache through write( ) and writing the logs in the storage device 102 through a function such as, for example, fdatasync( ) or fsync( ). The DIO may refer to a function of the file system through which a user reads data from the storage device 102 or writes data in the storage device 102. Through the DIO, data may not be written in the page cache, but straightly written in the storage device 102. Here, the term “write” may have the same meaning of “record.” That is, the data may bypass the page cache and not be temporarily stored in the page cache, but immediately written in the storage device 102.

The example embodiments described herein may be applicable to a journal mode supported in a database, for example, DELETE, TRUNCATE, PERSIST, WAL, MEMORY, and OFF. Here, for the database, a method of preventing an unexpected system failure may be required. The database may use a journal file that retains a log for restoration from a crash. To ensure a transaction, the database may commit the log to the journal file or update the database 101, and synchronize a log file and a database file using fdatasync( ). The committing may indicate that a result of performing a transaction is reflected in the database 101 and remains therein permanently.

The committing of a log may refer to a process of storing, in the blocks pre-allocated for the journal file, the logs, which are database restoration information indicating a change in data in the database 101.

The protection device 103 may remove file system journaling by performing the pre-allocation of the initialized blocks and the journaling to appropriately protect metadata of a file against an unexpected system crash. Here, the journaling may refer to a method of storing a history of change in data in a log, for example, a journal, before storing the history of change in data in the storage device 102. The journaling may be used to prevent data from abnormal damage that may occur when a system failure occurs while the history of change in data is being stored.

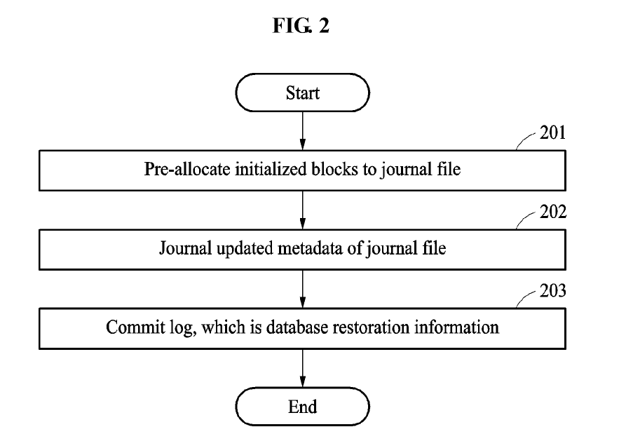

FIG. 2 is a flowchart illustrating a protection method for metadata of a file according to an example embodiment. Here, the protection method may refer to a method of protecting metadata of a file, and may be performed by a protection device.

Referring to FIG. 2, in operation 201, the protection device pre-allocates initialized blocks for a journal file. Here, pre-allocation refers to allocating in advance a block when or before generating a journal file for writing a log, which is database restoration information. The initialized blocks may be allocated in advance to a storage device.

In operation 202, the protection device journals updated metadata of the journal file. Here, the protection device may journal the metadata by synchronizing, to the storage device, the metadata of the journal file present in a database through a data synchronization function such as, for example, fdatasync( ).

In operation 203, the protection device commits the log, which is the database restoration information, to the storage device from the database using a DIO or a buffered IO. The log may then be stored in the allocated blocks for the journal file.

When the log is written in all the pre-allocated blocks through the committing performed in operation 203, the protection device may allocate new blocks of a preset size. When a size of the journal file changes due to the allocation, the metadata of the journal file may change. The protection device may then synchronize the changed metadata to the storage device through the journaling performed as in operation 202.

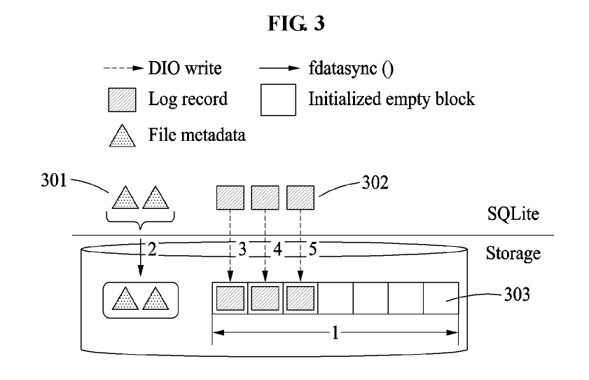

FIG. 3 is a diagram illustrating an example of a protection method for metadata of a file according to an example embodiment.

According to an example embodiment, to commit logs 302 to a journal file, a DIO-based write operation or a buffered IO-based write operation may be suggested. The logs 302 may be directly written in a storage device through a DIO or written in the storage device after being temporarily stored in a page cache through a buffered IO. In the committing of the logs 302, any updates associated with data blocks 303 or metadata 301 may not be involved in entries of the page cache. Thus, a database synchronization process, for example, fdatasync( ), may not trigger any file system journaling associated with an IO.

Through the committing of the logs 302, an interference of journaling may be eliminated, and the metadata 301 of the journal file may be protected. As described above, pre-allocation with explicit journaling may include pre-allocating a preset quantity of initialized blocks, for example, the data blocks 303, for the journal file, and journaling the metadata 301 for the generated journal file by calling fdatasync( ). In related arts, to protect the metadata 301 of the journal file of a database, file system journaling may be used. In such a case, an operation of committing all the logs 302 to involve such a file system journaling may be restricted. However, according to an example embodiment, the file system journaling may be eliminated and thus such a restriction may be resolved.

Referring to FIG. 3, the initialized data blocks 303 for the journal file may be allocated in advance. The blocks 303 may be allocated in advance to the storage device. The metadata 301 of the journal file may be synchronized through fdatasync( ) for journaling. That is, the metadata 301 of the journal file may be stored in the storage device. The logs 302 may be committed to the journal file through the DIO. That is, the logs 302, which are the database restoration information, may be written in the blocks 303 pre-allocated to the storage device immediately through the DIO without passing through the page cache.

A file system may maintain an initialized flag for each of the blocks 303. When a flag is set, the blocks 303 may be initialized. Any attempts to read the blocks 303 that are not initialized may return mode 0. Such a mechanism may be to prevent an exposure of stale data.

When pre-allocating the blocks 303 for the journal file, the DIO based on the committing of the logs 302 may not allocate a write operation. The entries of the page cache and the metadata 301 of the journal file may then be maintained intactly. In a journal mode according to an example embodiment, the committing of the logs 302 may not leave any space for a file system journaling module that may cause interference. The journal mode may protect the database from the file system journaling. When the journal file is generated or extended, the journal mode may call fdatasync( ) to synchronize the metadata 301. When the explicit journaling is involved, the journal file may be robust against a system error or failure.

When pre-allocating the blocks 303, special protection may be required for initialization of the allocated blocks 303. After an unexpected system failure occurs, the logs 302 that are written in the journal mode may not be read. A fallocate( ) system call of the file system may return the blocks 303 that are not initialized. When the blocks 303 are initially written, the blocks 303 may be initialized. When writing the blocks 303 through the DIO, the file system may set the initialized flag in response to the blocks 303 not being initialized. However, the DIO writing may not involve the file system journaling, and thus an updated flag may be lost due to an unexpected system failure.

The allocated blocks 303 may be initialized through the following three methods. A first method may include filling the allocated blocks 303 with zero 0. A second method and a third method may use a discard (or trim) command in an embedded multimedia card (eMMC), which is the storage device, to protect the stale data from being exposed. The eMMC may refer to a storage device in which a Nand flash memory and a flash memory controller are integrated as a package. Since the eMMC supports a fast input and/or output speed, the eMMC may be used for mobile devices. However, the number of times for write and delete may be restricted due to a characteristic of a Nand flash storage. The discard command may take a list of addresses of the logical blocks 303 as an input, and make a request so that the eMMG storage device eliminates mapping table entries for the logical blocks 303.

The second method may include mounting a discard option to the file system, and modifying fallocate( ) that allocates the blocks 303 having an initialized flag set. When the file system uses a discard mount option, the discard command may be issued in response to the allocation of the file blocks 303 being cancelled. To compel fallocate( ) that returns the blocks 303 having the initialized flag set, a method of porting a no-hide-stale patch in a linux source for a smartphone may be suggested.

The third method may include allocating the blocks 303 having the initialized flag set, and modifying fallocate( ) that discards the allocated blocks 303. The discard command may be embedded in the no-hide-stale patch developed for the second method, and a new flag of no-hide-stale discard for fallocate( ) may be suggested.

A major difference between the second method and the third method may be a time at which the blocks 303 are unmapped. In the second and the third methods, when the allocation of the file blocks 303 is cancelled or the file blocks 303 are allocated, the file blocks 303 may be unmapped. In the second method, the file system may issue the discard command for all the blocks 303 for which the allocation is cancelled. In contrast, in the third method, the file system may discard the file blocks 303 that are to be allocated to the journal file. The third method may have a smaller overhead than the second method.

The zero-fill process of filling the blocks 303 with zero may involve an IO overhead. Using the discard mount option may slow a speed of the file system. A recent smartphone may mount the discard option to the file system. The discard option may be designed to make a garbage collection more effective. However, the discard option may not be designed to hide stale contents.

An eMMC standard may not define whether reading is necessary when approaching the discarded blocks 303. An eMMC storage device may return all the zeros 0 when approaching the discarded blocks 303. When using the discard command to hide the stale contents, it needs to be ensured that the eMMC storage device does not expose the stale contents. In such a case, it may be ensured that all the zeros 0s are returned or all ones 1s are returned when approaching the discarded blocks 303.

According to an example embodiment, using the trim command may be needed although a greater amount of an overhead may occur. When approaching the trimmed blocks 303, the trim command may return all the zeros 0s or all the ones 1s. Also, to ensure the given eMMC storage device, a discard command from a host in a certain environment may not be ignored, although the eMMC storage device performs the garbage collection on background.

According to example embodiments described above, significantly reducing an amount of an input and output that is actually generated when a content written in a file is synchronized to a storage device may improve a performance of the storage device and extend a life of the storage device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A protection method comprising:
pre-allocating, to a storage device, a preset quantity of initialized blocks for a journal file; and
journaling, in the storage device, updated metadata of the journal file by calling a data synchronization function.

2. The protection method of claim 1, further comprising:
committing a log, which is database restoration information, to the blocks.

3. The protection method of claim 2, wherein the committing comprises:
writing the log in the blocks pre-allocated to the storage device from a database, through a direct input and output (DIO) method or a buffered input and output (IO) method.

4. The protection method of claim 1, wherein the journaling comprises:
storing, in the storage device, the metadata of the journal file by synchronizing the metadata through the data synchronization function.

5. The protection method of claim 1, wherein the blocks allocated to the storage device are initialized by filling the blocks with zero, or applying a discard command to the storage device.

6. The protection method of claim 1, further comprising:
re-allocating a preset quantity of blocks when all the allocated blocks are full by committing a log.

7. The protection method of claim 6, further comprising:
journaling the metadata of the journal file by synchronizing the metadata when a size of the journal file changes in response to the re-allocation of the blocks.

8. A protection device performing a protection method for metadata of a file, the protection device comprising:
a processor,
wherein the processor is configured to:
pre-allocate, to a storage device, a preset quantity of initialized blocks for a journal file; and
journal, in the storage device, updated metadata of the journal file by calling a data synchronization function.

9. The protection device of claim 8, wherein the processor is further configured to commit a log, which is database restoration information, to the blocks after journaling the metadata.

10. The protection device of claim 9, wherein the processor is configured to write the log in the blocks pre-allocated to the storage device from a database through a direct input and output (DIO) method or a buffered input and output (IO) method.

11. The protection device of claim 8, wherein the processor is configured to perform the journaling by storing, in the storage device, the metadata of the journal file by synchronizing the metadata through the data synchronization function.

12. The protection device of claim 8, wherein the blocks allocated to the storage device are initialized by filling the blocks with zero, or applying a discard command to the storage device.

13. The protection device of claim 8, wherein the processor is further configured to re-allocate a preset quantity of blocks when all the allocated blocks are full by committing a log.

14. The protection device of claim 13, wherein the processor is further configured to journal the metadata of the journal file by synchronizing the metadata when a size of the journal file changes in response to the re-allocation of the blocks.
